(19) United States
(12) Patent Application Publication
(10) Pub. No.: US 2011/0255599 A1
(43) Pub. Date: Oct. 20, 2011

(54) APPARATUS AND METHOD FOR MOTION ESTIMATION

(75) Inventors: Piergiorgio SARTOR, Fellbach (DE); Matthias BRUGGEMANN, Bueren-Brenken (DE)

(73) Assignee: Sony Corporation, Tokyo (JP)

(21) Appl. No.: 13/079,322

(22) Filed: Apr. 4, 2011

(30) Foreign Application Priority Data
Apr. 15, 2010 (EP) 10003995.7

(51) Int. Cl. H04N 7/26

(52) U.S. Cl. 375/240.16; 375/E07.125

(57) ABSTRACT

A device for motion estimation (100) includes a block characteristic measurement unit (110) configured to determine an image characteristic of a source block (210) of a reference frame (200). Motion of the source block (210) of the reference frame (200) with regard to a current frame is estimated by a motion estimation unit (120), wherein the motion of the source block (210) is estimated by either a motion estimation method other than phase correlation or by phase correlation depending on the image characteristic.

Embodiments of the invention relate to a device for motion estimation and to a method for estimating motion of a source block of a reference frame with regard to a current frame.

Motion estimation techniques form the core of video compression and video processing applications such as frame rate converters. These techniques may differ with regard to accuracy, speed, complexity or stability.

The object underlying the invention is to provide a device for motion estimation having overall improved characteristics. A further object is to provide a method for estimating motion of a source block in a reference frame with regard to a current frame.

Details of the invention will become apparent from the following description of embodiments in connection with the accompanying drawings. The features of the various embodiments may be combined unless they exclude each other.

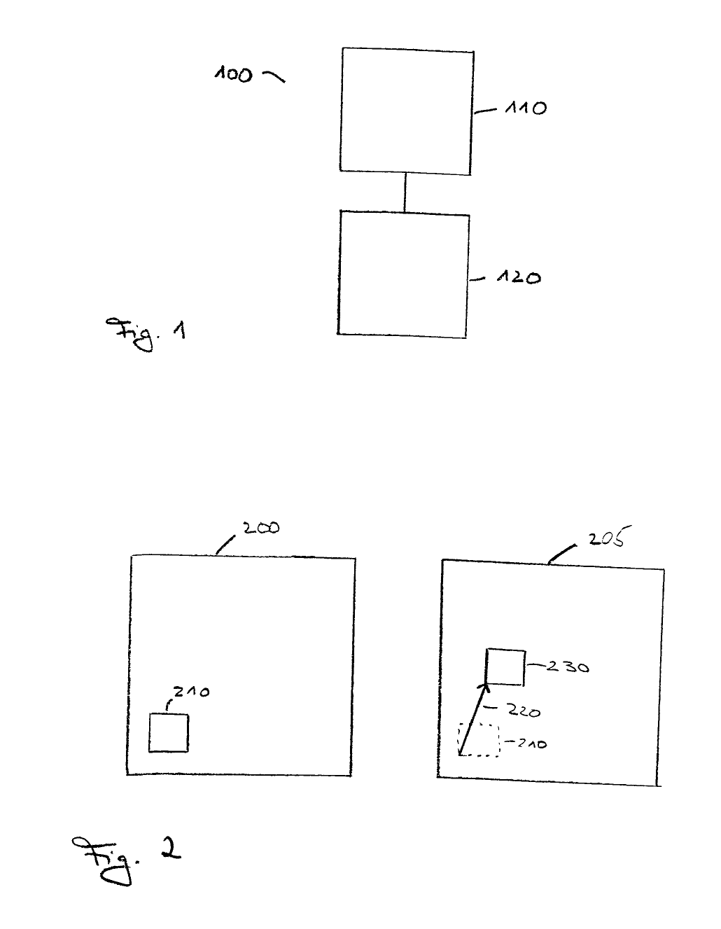

FIG. 1 is a schematic illustration of a device for motion estimation in accordance with an embodiment.

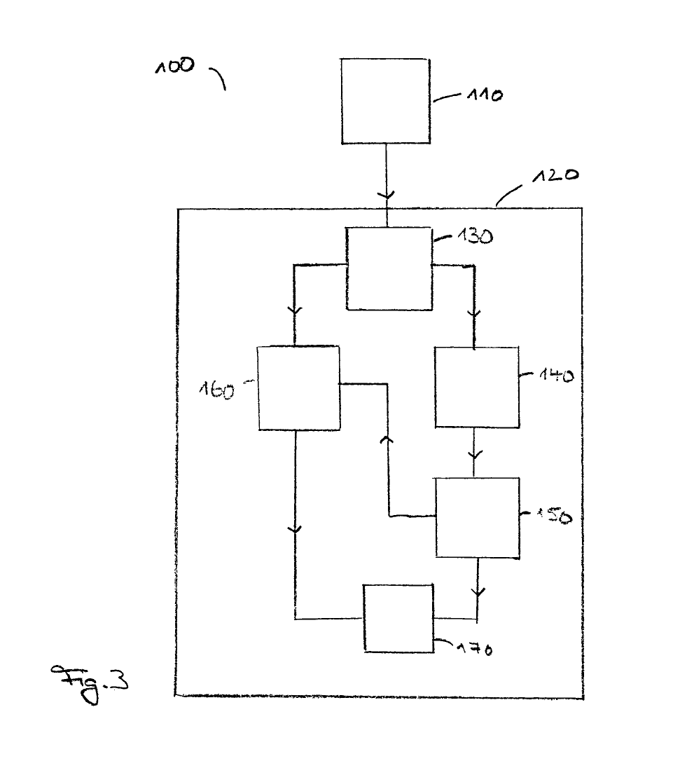

FIG. 2 is a simplified illustration of a source block in a reference frame and a target block in a current frame defined by a candidate vector.

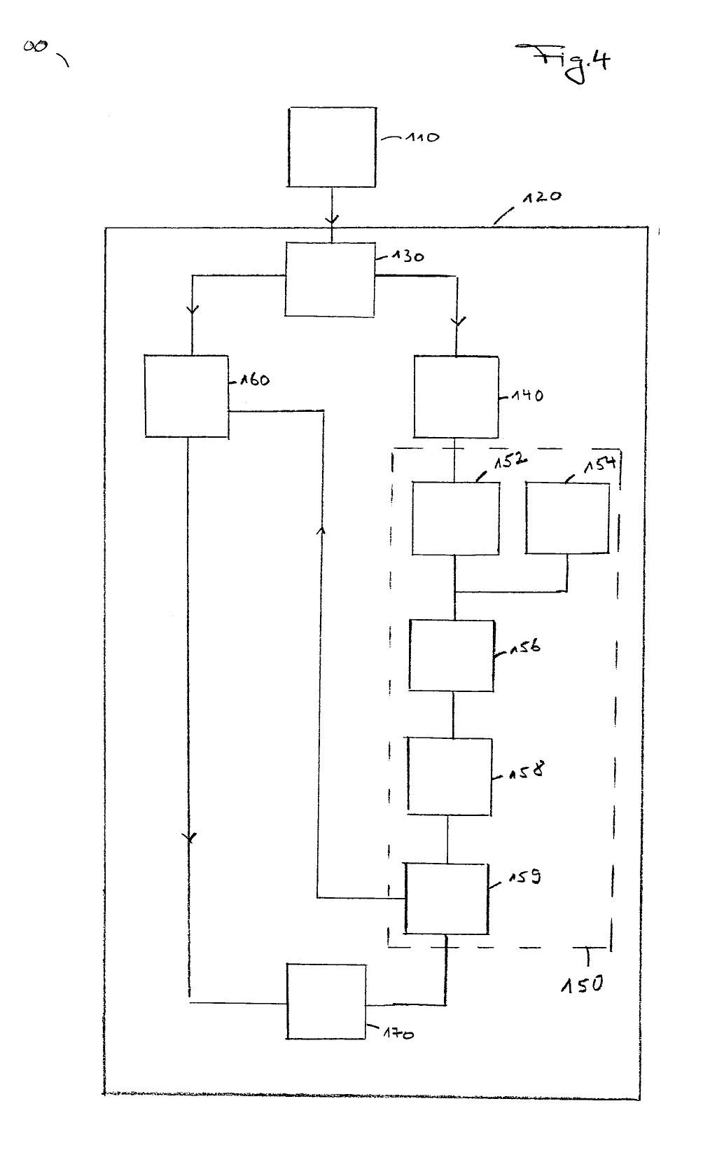

FIG. 3 is related to the device for motion and estimation of FIG. 1 and illustrates details of a motion estimation unit in accordance with an embodiment.

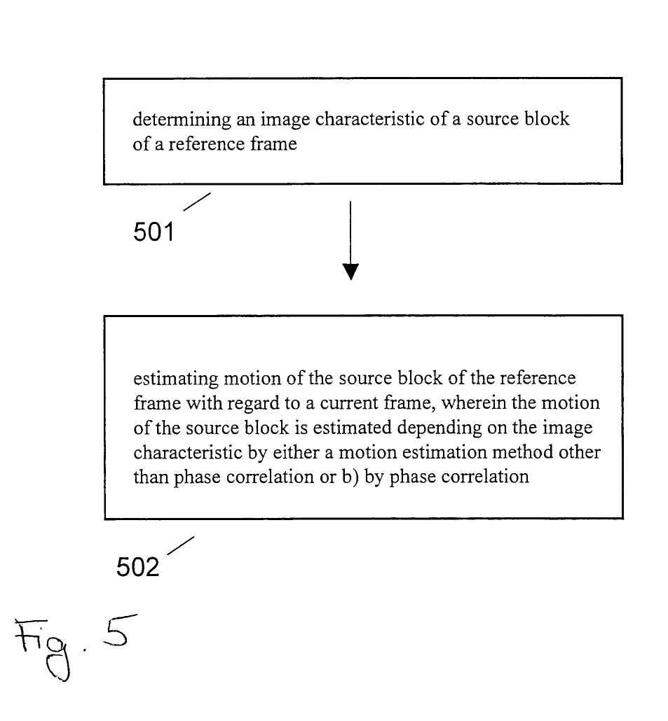

FIG. 4 is related to the devices for motion estimation of FIGS. 1 and 3 and illustrates details of an evaluation unit in accordance with an embodiment.

FIG. 5 is a simplified flow chart for illustrating a method for estimating motion of a source block in a current frame with regard to a reference frame.

FIG. 1 refers to a device for motion estimation 100 which may be included in a variety of applications including video processing such as TV receivers. The device for motion estimation 100 may include a block characteristic measurement unit 110 configured to determine an image characteristic of a source block of a reference frame. The device for motion estimation 100 may also include a motion estimation unit 120 configured to estimate motion of the source block of the reference frame with regard to a current frame, wherein the motion of the source block is estimated depending on the image characteristic. In other words, the method for estimating motion of the source block in the reference frame with regard to the current frame depends on the image characteristic of the source block. In more detail, the image characteristic determines whether the motion of the source block is estimated by a motion estimation method other than phase correlation or by phase correlation.

In accordance with an embodiment, the block characteristic measurement unit 110 includes a feature point extraction unit configured to extract a feature point within the source block. The image characteristic is then related to the presence of a feature point. As a feature point, characteristic areas in a picture such as a corner or an edge may be used, for example. As an example, the block characteristic measurement unit 110 may be configured to extract corners in the source block by making use of a maximum of the Hesse determinant. Apart from extracting a single feature point within the source block, the block characteristic measurement unit 110 may also extract a plurality of feature points within the source block. The result of the block characteristic measurement unit 110 may thus be related to the presence, type or shape of one or multiple feature points in the source block of the reference frame.

In accordance with other embodiments, the block characteristic measurement unit 110 may determine the image characteristic of the source block of the reference frame on the basis of whether the source block is a flat block or not. According to yet another embodiment, the block characteristic measurement unit 110 may determine the image characteristic of the source block of the reference frame on the basis of whether the source block is a textured block or not. The block characteristic measurement unit 110 may also determine the block characteristic with regard to picture properties such as noise, colour, contrast, e.g. similar or flat, or brightness.

The size of the source block may be smaller than the size of the reference frame. As an example, the size may be equal to any one of 32×32, 32×16, 16×32, 16×16, 16×8, 8×16, 8×8, 8×4, 4×8, 4×4 pixel. According to another example, the block sizes may also be different from power-of-two sizes.

In accordance with an embodiment, the motion estimation unit 120 is configured to estimate motion of the source block of the reference frame depending on the image characteristic either by a block matching method such as 3D recursive motion estimation or by phase correlation. According to another embodiment, the motion estimation method other than phase correlation may be any one of a full-search algorithm or a motion model-based estimation.

According to an embodiment, the motion estimation unit 120 may, in case of motion estimation of the source block by phase correlation, again estimate the motion of the respective source block by the motion estimation method other than phase correlation, e.g. block matching, if the motion estimated by phase correlation does not fulfill predetermined criteria, e.g. if it is considered not good enough. As an example, the predetermined criteria may be related to any one or any combination of number of peaks, ratio between peaks, peak dimensions such as width, maximum peak height, noise carpet level. As a further example, the decision of whether the phase correlation results meet a certain criteria may be determined by comparing the phase correlation result with one or several threshold values, which may be predetermined and/or programmable.

For purpose of illustration of basics of motion estimation, the left part of FIG. 2 refers to a reference frame 200 including a source block 210. Motion of the source block 210 with regard to a current frame such as a target frame 205 illustrated in the right part of FIG. 2 may be estimated by the device for motion estimation 100 of FIG. 1. In the target frame 205, e.g. the current frame, motion of the source block 210 (the position of source block 210 in source frame 200 is indicated in the target frame 205 by dashed lines for illustration purposes) may be evaluated on the basis of one candidate vector 220 or a plurality of candidate vectors. The candidate vector 220 determines the motion of the source block 210 from the source frame 200 to the target block 230 in the target frame 205. The candidate vector 220 or a plurality of candidate vectors may be known from previous estimations, for example. As an example, a number of candidate vectors involved in estimating motion of the source block 210 of the reference frame 200 may range from 1 to 5, for example. For each candidate vector 220, the target block 230 may be set in relation to the source block 210 depending on the motion estimation method used, and one candidate vector may be selected to determine motion of the respective source block 210 between the source frame 200 and the target frame 205.

FIG. 3 relates to the device for motion estimation 100 illustrated in FIG. 1 and provides details with regard to the motion estimation unit 120 in accordance with an embodiment.

The motion estimation unit 120 may include a decision unit 130 configured to decide whether estimation of motion of a source block of a reference frame with regard to a current frame is either carried out by phase correlation or by a motion estimation method other than phase correlation such as block matching, e.g. 3D parallel recursive motion estimation. For illustration purposes, the following description will relate to block matching as the method other than phase correlation. However, other motion estimation methods may also be used. The decision unit 130 may decide on which method estimation of motion is based upon by considering an image characteristic of the source block provided by the block characteristic measurement unit 110.

In case the decision unit 130 decides that block matching is to be carried out, e.g. because the source block in the reference frame lacks any feature points, the block matching unit 160 may estimate motion of the source block in the reference frame with regard to the current frame by block matching.

In case the decision 130 comes to the conclusion that phase correlation is to be carried out to determine motion of the source block of the reference frame with regard to the current frame, a candidate vector selection unit 140 may select one or multiple candidate vectors. These candidate vectors may be chosen as the candidate vectors of previous estimations. Apart from spatial/temporal estimation, candidate vectors may be provided by other means, e.g. external means, of motion estimation/detection. For example, a static area detection may deliver a zero vector with a certain degree of reliability. This vector may be be further checked in the motion estimation process. Also a global motion estimator may provide information related to a picture panning, which may be considered a candidate vector.

On the basis of the candidate vectors selected by the selection unit 140, an evaluation unit 150 evaluates the motion of the source block estimated by phase correlation, wherein depending on a result this evaluation, the motion of the source block is either determined to be the motion estimated by phase correlation, which is forwarded to an output unit 170, or is again estimated by the block matching unit 160. In latter case the motion estimated by phase correlation may be disregarded or information derived from the phase correlation result may be used to set up block matching. As an example, block matching may be carried out if the evaluation unit comes to the conclusion that a result of phase correlation does not meet predetermined criteria so that the evaluation unit instructs the block matching unit 160 to estimate motion of the respective source block in the current frame with regard to the target frame by block matching. The block matching unit 160 forwards the estimated motion of the source block to the output unit 170.

The device for motion estimation 100 allows both accurate and fast converging motion estimation such as known from phase correlation alone and stable and robust motion estimation such as known from block matching alone. In addition, the overall computational complexity of motion estimation carried out by device 100 may be lowered compared to a device carrying out motion estimation by phase correlation exclusively. This may be due to the limited and reduced usage of phase correlation in device 100.

FIG. 4 is related to the devices for motion estimation illustrated in FIGS. 1 and 3 and provides further details on the evaluation unit 150 in accordance with an embodiment.

The evaluation unit 150 includes a feature point extraction unit 152 configured to extract one or multiple feature points in the target block. The feature point extraction unit 152 may share functional elements with the block characteristic measurement unit 110. As an example, the block characteristic measurement unit 110 and the evaluation unit 150 may use one feature point extraction unit in common.

The evaluation unit 150 may also include a global motion model match unit 154 configured to evaluate matching of the candidate vector selected by the candidate vector selection unit 140 and a global motion vector. The global motion vector may be input to the global model match unit 154, for example. A global motion vector determined by a global motion model may refer to an image area larger than the source block, e.g. to a whole frame. Global motion vectors may be determined by evaluating statics of motion of a plurality of feature points already known, for example. As a further example, global motion vectors may also be determined by full-screen panning detection or by model based motion estimation, for example. With regard to each one of the candidate vectors selected by the candidate vector selection unit 140, a phase correlation applicability unit 156 may estimate applicability of phase correlation, wherein criteria of rising applicability of phase correlation may include extraction of a feature point in the respective target block by the feature point extraction unit 152 and matching of the respective candidate vector with a global motion vector determined by the global motion model match unit 154.

As an example, Table 1 includes a list of applicabilities of phase correlation with regard to a target block associated with a candidate vector.

TABLE 1
Example of phase correlation applicability that may be applied to each
one of the candidate vectors.

| Feature point in | Match with global | Phase correlation |
|---|---|---|
| target block | motion vector | applicability |
| no | no | low |
| no | yes | medium |
| yes | no | high |
| yes | yes | very high |

The applicability of phase correlation will be highest if a feature point can be extracted by the feature point extraction unit 152 in the target block associated with a respective candidate vector and if the global model match unit 154 identifies matching between the respective candidate vector and a global motion vector. Contrary thereto, the applicability of phase correlation will be lowest if the feature point extraction unit 152 cannot identify a feature point in the target block associated with the respective candidate vector and if the global motion model match unit 154 fails to identify matching of the respective candidate vector and a global motion vector. Applicability of phase correlation with regard to each one of the candidate vectors may be stored in the phase correlation applicability unit in form of a table, for example.

The motion estimation unit may also include a phase correlation unit 158 configured to perform phase correlation between a source block in a reference frame and a target block in a target frame, e.g. current frame. In accordance with an embodiment, the motion estimation unit 120 is configured to estimate motion of the source block by phase correlation with regard to the target block defined by the candidate vector determined by the phase correlation applicability unit 156 to have the highest applicability of phase correlation. In accordance with another embodiment, the motion estimation unit 120 estimates motion of the source block by phase correlation with regard to the target blocks defined by all candidate vectors selected by the candidate vector selection unit 140. According to yet another embodiment, phase correlation may be carried out with regard to multiple candidate vectors, the multiple candidate vectors being those candidate vectors that include the highest applicability of phase correlation among all candidate vectors. These phase correlations may be carried out by the phase correlation unit 158.

The evaluation unit 150 may also include an assessment unit 159 configured to evaluate the result of phase correlation determined by the phase correlation unit 158, wherein depending on a result this evaluation, the motion of the source block is either determined to be the motion estimated by phase correlation, which is forwarded to an output unit 170, or is again estimated by the block matching unit 160.

According to a method for motion estimation illustrated in the flow chart of FIG. 5, an image characteristic of a source block of a reference frame is determined, e.g. by extracting feature points within the source block, the image characteristic being related to the presence of a feature point within the respective block (501).

Then, motion of the source block of the reference frame is estimated with regard to a current frame depending on the image characteristic. Either a motion estimation method other than phase correlation such as block matching or phase correlation is chosen for estimating motion of the respective source block (502).

With regard to further details on the method illustrated in FIG. 5, reference is taken to the functional description related to embodiments elucidated above with reference to FIGS. 1 to 4.

1. A device for motion estimation (100), comprising:
a block characteristic measurement unit (110) configured to determine an image characteristic of a source block (210) of a reference frame (200);
a motion estimation unit (120) configured to estimate motion of the source block (210) of the reference frame (200) with regard to a current frame (205), wherein the motion of the source block (210) is estimated depending on the image characteristic a) by a motion estimation method other than phase correlation or b) by phase correlation.

2. The device (100) of claim 1, wherein
the motion estimation unit (120) includes an evaluation unit (150) configured to evaluate the motion of the source block (210) estimated by phase correlation, wherein depending on a result of evaluation, the motion of the source block (210) is a) determined as the motion estimated by phase correlation or b) again estimated by the motion estimation method other than phase correlation.

3. The device (100) of claim 1, wherein
the block characteristic measurement unit (110) includes a feature point extraction unit configured to extract a feature point within the source block (210), the image characteristic being related to the presence of the feature point; and wherein
the motion estimation unit (120) estimates the motion of the source block (210) by the motion estimation method other than phase correlation if no feature point is present in the source block (210) and estimates the motion of the source block (210) by phase correlation if a feature point is present in the source block (210).

4. The device (100) of claim 1, wherein
the motion estimation method other than phase correlation is any one of block matching, optical flow and motion model based estimation.

5. The device (100) of claim 1, further comprising
a candidate vector selection unit (140) configured to select at least one candidate vector (220) for motion estimation by phase correlation;
a feature point extraction unit (152) configured to extract a feature point within a target block (230) defined by the source block (210) and the at least one candidate vector (220);
a global motion model match unit (154) configured to evaluate matching of the at least one candidate vector (220) and a global motion vector, the global motion vector being input to the global motion model match unit (154); and
a phase correlation applicability unit (156) configured to estimate applicability of phase correlation with regard to each one of the at least one candidate vectors (220), wherein criteria of rising applicability of phase correlation include extraction of a feature point in the respective target block (220) by the feature point extraction unit (152) and matching of the respective candidate vector with a global motion vector determined by the global motion model match unit (154).

6. The device (100) of claim 5, wherein
the motion estimation unit (120) is configured to estimate motion of the source block (210) by phase correlation with regard to the target block (230) defined by the candidate vector (220) determined by the phase correlation applicability unit (156) to have the highest applicability of phase correlation.

7. The device (100) of claim 1, wherein
the motion estimation unit (120) is configured to estimate motion by phase correlation of blocks of a frame, wherein the size of each of the blocks equals any one of 32×32, 32×16, 16×32, 16×16, 16×8, 8×16, 8×8, 8×4, 4×8, 4×4 pixel.

8. A method for motion estimation, comprising:
determining an image characteristic of a source block (210) of a reference frame (200); and
estimating motion of the source block (210) of the reference frame (200) with regard to a current frame (205), wherein the motion of the source block (210) is estimated depending on the image characteristic a) by a motion estimation method other than phase correlation or b) by phase correlation.

9. The method of claim 8, further comprising
evaluating the motion of the source block (210) estimated by phase correlation, wherein, depending on a result of evaluation, the motion of the source block (210) is a) determined as the motion estimated by phase correlation or b) again estimated by the motion estimation method other than phase correlation.

10. The method of claim 8, further comprising
examining the source block (210) with regard to presence of a feature point, the image characteristic being related to the presence of the feature point; and
estimating the motion of the source block (210) by the motion estimation method other than phase correlation if no feature point is present in the source block (210) and estimating the motion of the source block by phase correlation if a feature point is present in the source block (210).

11. The method of claim 8, wherein
the motion estimation method other than phase correlation is any one of block matching, motion model based estimation.

12. The method of claim 8, further comprising
selecting at least one candidate vector (220) for motion estimation by phase correlation;
examining a target block (230) with regard to presence of a feature point, the target block (230) being defined by the source block (210) and the at least one candidate vector (220);
evaluating a match of the at least one candidate vector (220) and a global motion vector; and
estimating applicability of phase correlation with regard to each one of the at least one candidate vectors (220), wherein criteria of rising applicability of phase correlation include presence of a feature point in the respective target block (220) and matching of the respective candidate vector (220) with a global motion vector.

13. The method of claim 12, further comprising
estimating motion of the source block (210) by phase correlation with regard to the target block (230) defined by the candidate vector (220) having the highest applicability of phase correlation.

14. The method of claim 9, wherein
the phase correlation is carried out with regard to the source block (210) and the target block (230), wherein the size of each of these blocks equals any one of 32×32, 32×16, 16×32, 16×16, 16×8, 8×16, 8×8, 8×4, 4×8, 4×4 pixel.

15. A consumer electronic device including the device for motion estimation (100) according to claim 1.
